(19) United States
(12) Patent Application Publication
(10) Pub. No.: US 2015/0286548 A1
(43) Pub. Date: Oct. 8, 2015

(54) INFORMATION PROCESSING DEVICE AND METHOD

(71) Applicant: FUJITSU LIMITED, Kawasaki-shi (JP)

(72) Inventor: Yustinus JULI, Yokohama (JP)

(73) Assignee: FUJITSU LIMITED, Kawasaki-shi (JP)

(21) Appl. No.: 14/745,583

(22) Filed: Jun. 22, 2015

Related U.S. Application Data
(63) Continuation of application No. PCT/JP2012/084154, filed on Dec. 28, 2012.

(51) Int. Cl. G06F 11/30

(52) U.S. Cl. CPC G06F 11/3048; G06F 11/3068

(57) ABSTRACT

An information processing device includes a processor that executes a procedure. The procedure includes: acquiring a load condition that is related to input and output of data to and from a device included in the information processing system and determines a load added to the information processing system; based on the acquired load condition, finding a load added to the information processing system during operation, and adding the found load to the information processing system; acquiring a response time of the device with respect to a request for input or output of data when the load is added to the information processing system, and acquiring load information indicating a correlation with the response time; and based on the acquired load information, setting a response monitoring time of from when the request for input or output of data to or from the device was made until the device responds.

### CROSS-REFERENCE TO RELATED APPLICATION

This application is a continuation application of International Application No. PCT/JP/2012/084154, filed Dec. 28, 2012, the disclosure of which is incorporated herein by reference in its entirety.

### FIELD

The embodiments discussed herein are related to an information processing device, an information processing method, and a recording medium storing an information processing program.

### BACKGROUND

Information processing systems are known that perform business processing using computers. Data used when performing business processing using computers is generally stored for use on a storage device, such as a hard disk drive (HDD). There is sometimes an impact on business processing when a failure occurs in a device such as a storage device employed by the computer.

The level of redundancy of storage devices is therefore increased using redundancy technology such as mirroring in order to suppress the impact of failure of a storage device used in business processing. For example, in redundancy technology known as disk mirroring, the same content is stored on plural local disk drives. In redundancy technology, data is simultaneously written to plural disks or plural storage devices, and reading of data is performed from a single disk or a single storage device that is predetermined as the master.

In redundancy technology, when a failure arises in the single disk or single storage device that is the master, processing is performed to circumvent the failure, such as rapid switching to make another disk or another storage device the master. When a failure arises in a disk or storage device in cases in which business processing is performed using a computer, the time that is needed for processing to circumvent the failure, such as for switching to another disk or another storage device, becomes an impediment to business processing continuity. To suppress the impact of disk or storage device failure on business processing, timeout technology is known that monitors responses to input/output requests (I/O requests), and deems there to be no response after a specific time has elapsed. Namely, timeout technology is technology including a function of suppressing response delays in storage devices.

One example of timeout technology is technology that sets a timeout time for monitoring responses to I/O requests. For example, technology is known that sets the timeout time according to the functionality of the information processing system measured when the information processing system is under a constant load. In such technology, the number of input/output commands per unit of time when the information processing system is under a constant load, and response times with respect to the number of input/output commands are collected as processing functionality information. Then, based on the collected processing functionality information, an estimated value for the timeout time is found and set as the timeout time.

Moreover, technology in which timeout times according to load are queried for each I/O request is known as another example of setting a timeout time. In such technology, the timeout time is set for each I/O request according to the load on the computer.

### RELATED PATENT DOCUMENTS

Japanese Laid-Open Patent Publication No. 2010-113383

Japanese Laid-Open Patent Publication No. 2005-165658

### SUMMARY

According to an aspect of the embodiments, a information processing device includes a processor configured to execute a process, the process including: acquiring a load condition that is predetermined according to an information processing system, and that is related to input and output of data to and from a device included in the information processing system and determines a load to be added to the information processing system; based on the acquired load condition, finding a load to be added to the information processing system during operation, and adding the found load to the information processing system; acquiring a response time of the device with respect to a request for input or output of data when the load is added to the information processing system, and acquiring load information indicating a correlation with the response time; and based on the acquired load information, setting a response monitoring time of from when the request for input or output of data to or from the device is made until the device responds.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a case in which an information processing device according to an exemplary embodiment is implemented by a computer;

FIG. 2 is an illustrative diagram illustrating an example of an I/O characteristics table;

FIG. 3 is a block diagram illustrating an example of looking at the functionality of various programs;

FIG. 4 is a flowchart illustrating an example of a flow of processing of an initial stage of a monitoring daemon program;

FIG. 5 is a flowchart illustrating an example of a flow of processing that finds a timeout time in a monitoring daemon program;

FIG. 6 is an illustrative diagram illustrating an example of a relationship between I/O load and I/O response time;

FIG. 7 is a flowchart illustrating an example of a flow of processing of an operation stage of a monitoring daemon program;

FIG. 8 is a flowchart illustrating an example of a flow of processing to find a timeout time in a monitoring daemon program;

FIG. 9 is a flowchart illustrating an example of a flow of processing of an initial stage of an I/O monitoring driver;

FIG. 10 is a flowchart illustrating an example of a flow of processing when I/O load information of an I/O monitoring driver is requested;

FIG. 11 is a flowchart illustrating an example of a flow of processing of an operation stage of an I/O monitoring driver;

FIG. 12 is a flowchart illustrating an example of a flow of processing when a request is made to change an I/O timeout time of an I/O monitoring driver; and

FIG. 13 is a flowchart illustrating an example of a flow of processing of an I/O relay driver.

### DESCRIPTION OF EMBODIMENTS

Load in an information processing system changes according to business processing being executed in the information processing system. Thus sometimes timeout times corresponding to business processing executed in the information processing system are not settable as timeout times set using processing functionality information obtained by applying a constant load to the information processing system. Moreover, in cases in which the timeout time is set for each input/output request (I/O request) according to the load on the computer, an enquiry is needed for the timeout time each time an I/O request issued. The load for each I/O request accordingly increases.

An object of one aspect of technology disclosed herein is to increase response functionality in an information processing system.

Detailed explanation follows regarding an example of an exemplary embodiment of technology disclosed herein, with reference to the drawings.

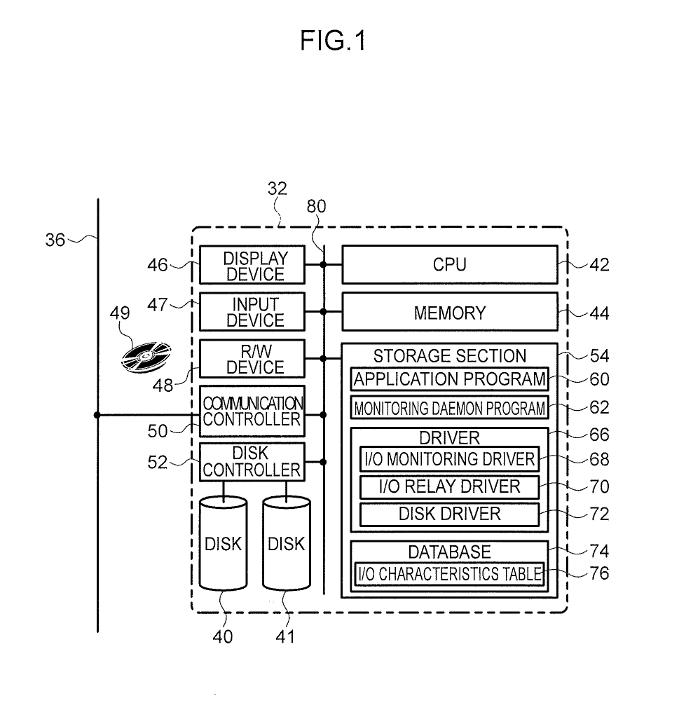

FIG. 1 illustrates an example of a case in which an information processing device according to the present exemplary embodiment is implemented by a computer.

The computer 32 includes a CPU 42, memory 44, and a non-volatile storage section 54. The CPU 42, the memory 44, and the storage section 54 are connected to one another through a bus 80. The storage section 54 may be implemented using a HDD, flash memory, or the like. The computer 32 includes a communication controller 50 for connecting to the network 36, and the communication controller 50 is connected to the bus 80. The computer 32 includes a display device 46 serving as an example of an output device, and an input device 47, such as a keyboard or mouse, serving as an example of an input device. The display device 46 and the input device 47 are connected to the bus 80. The computer 32 is provided with a device (an R/W device) 48 for reading from/writing to a recording medium 49 such as an optical disc when the recording medium 49 is inserted into the computer 32. The R/W device 48 is connected to the bus 80. Note that the display device 46, the input device 47, and the R/W device 48 may be omitted, or may be connected to the bus 80 when necessary.

The computer 32 also includes disks 40, 41 that store information, and the disks 40, 41 are connected the bus 80 through a disk controller 52. Note that the disks 40, 41 are subjected to redundancy by a known redundancy program. The redundancy program is software that executes redundancy processing on the disks 40, 41.

A program that employs redundancy technology known as disk minoring is an example of redundancy program. In processing using disk minoring, data with identical content is written to both of the disks 40, 41, and data is read from a single predetermined master. In the present exemplary embodiment, explanation follows in which the disk 40 is the single master disk. The processing using disk mirroring includes processing to recover from a failure, such as by rapid switching to make the disk 41 the master, when failure arises in the disk 40 in the computer 32.

In the following explanation, the disk 40 is referred to when distinguishing between the disks 40, 41 is unnecessary since the disks 40, 41 are subjected to redundancy by the processing using disk minoring.

Application programs 60 and a monitoring daemon program 62 are stored in the storage section 54. The application programs 60 and the monitoring daemon program 62 are classified as software executed on a user layer which is higher than the operating system (OS). Drivers 66 are stored in the storage section 54 and are classified as software that executes on the kernel layer of the OS. A database 74 that includes an I/O characteristics table 76 is stored in the storage section 54.

The application programs 60 are various types of program executed by the computer 32. The monitoring daemon program 62 is a program that monitors I/O load during operation of the computer 32, and changes an I/O timeout time according to business processing executed by the computer 32.

In the present exemplary embodiment, the monitoring daemon program 62 and the driver 66 are executed to suppress response time delays for business processing executed by the computer 32. The CPU 42 reads the monitoring daemon program 62 from the storage section 54, expands the monitoring daemon program 62 into the memory 44, and executes the monitoring daemon program 62. The CPU 42 also reads the drivers 66 from the storage section 54, expands the drivers 66 into the memory 44, and executes the drivers 66.

The drivers 66 include an I/O monitoring driver 68, an I/O relay driver 70, and a disk driver 72. The I/O monitoring driver 68 and the I/O relay driver 70 are classified as high-level drivers close to the user layer. The disk driver 72 is classified as a low-level driver close to the hardware layer.

The I/O monitoring driver 68 receives I/O requests from the application programs 60 and the like, and monitors the time from sending the I/O requests to a low-level driver until an I/O response is returned from the low-level driver. This time is taken as the I/O response time. The I/O monitoring driver 68 returns the I/O response from the low-level driver to, for example, the application program 60. However, an I/O cancellation request is sent to the I/O relay driver 70 in cases in which the I/O response time of the low-level driver exceeds a pre-set I/O timeout time.

The I/O monitoring driver 68 stores I/O load information. The I/O load information includes information indicating an average I/O response time (rt) within a specific time (t). The I/O load information also includes information indicating an average I/O response time (rt) within a specific time (t), and the I/O volume (iosize) in the specific time (t). The I/O load information also includes information indicating the I/O count (iops) and ratio (rdperc) for reading and writing in the specific time (t). When there is an enquiry for the I/O load information, the I/O monitoring driver 68 replies with the recorded I/O load information. The I/O monitoring driver 68 also updates the currently set I/O timeout time when a change notification for the I/O timeout time has been received.

The I/O relay driver 70 sends a cancel request to a low-level driver when an I/O cancellation request is received from the I/O monitoring driver 68.

The disk driver 72 executes data input or output with respect to the disk 40. Namely, the disk driver 72 processes data output to the disk 40 when input or output of data is requested to or from the disk 40.

The database 74 stored in the storage section 54 of the computer 32 includes the I/O characteristics table 76.

There are, however, differences in I/O load according to the I/O characteristics produced by the processing in the application program 60 that operates on the computer 32. For example, the frequency of data output to the disk 40 is high compared to data input when the computer 32 operates as a streaming server. Namely, there is more processing that reads data from the disk 40 than processing that writes data to the disk 40. Accordingly, the I/O load conditions that define the I/O load for the computer 32 are preferably set to conform to the type of application program 60 operating on the computer 32 and the content of the business processing employing the computer 32. Therefore, in the present exemplary embodiment, information indicating the I/O characteristics according to the application program 60 or according to the business processing employing the computer 32 is stored in the I/O characteristics table 76 as I/O load conditions.

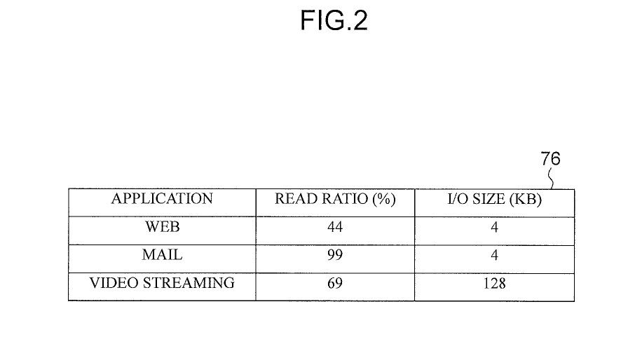

FIG. 2 illustrates an example of the I/O characteristics table 76. In the I/O characteristics table 76, information indicating a name that identifies the application program 60 or identifies the business processing employing the computer 32 is registered in an “application” item. FIG. 2 illustrates an example in which information indicating “web”, “mail”, and “video streaming” are stored as the information of the “application” item. “Web” indicates cases in which the computer 32 operates as a webserver. “Mail” indicates that the computer 32 operates as a mail server. “Video streaming” indicates cases in which the computer 32 operates as a video streaming server.

The I/O characteristics table 76 is pre-registered by the user. For example, information indicating I/O characteristics is registered, modified, or erased in the I/O characteristics table 76 when the application program 60 or the business processing employing the computer 32 is added to, modified, or erased. Moreover, information indicating I/O characteristics corresponding to each of plural types of business processing is registered when there are plural types of business processing performed using the computer 32. In the example of FIG. 2, an additional row is registered in the I/O characteristics table 76 when information indicating I/O characteristics is added.

Note that the computer 32 is an example of an information processing device of technology disclosed herein. Namely, the computer 32 operates as an information processing device of technology disclosed herein by an information processing device of technology disclosed herein being implemented using the computer 32, and by the CPU 42 executing the monitoring daemon program 62 and the drivers 66.

The I/O timeout time is an example of a response monitoring time of technology disclosed herein. The monitoring daemon program 62 and the drivers 66 include examples of information processing programs of technology disclosed herein. The monitoring daemon program 62 and the driver 66 are programs that cause the computer 32 to function as an information processing device. The recording medium 49, such as an optical disc, stored with programs that cause the computer 32 to execute processing, is an example of a recording medium of technology disclosed herein. The HDD or the like that is an example of an implementation of the storage section 54 is also an example of a recording medium of technology disclosed herein.

The I/O characteristics table 76 included in the database 74 is an example of a table of technology disclosed herein. The database 74 stored in the storage section 54 of the computer 32 corresponds to a storage section storing a table of technology disclosed herein.

The CPU 42 operates as a monitoring section of technology disclosed herein by executing the I/O monitoring driver 68. The CPU 42 also operates as a relay section of technology disclosed herein by executing the I/O relay driver 70.

Next, explanation follows regarding operation of the present exemplary embodiment. Explanation follows regarding processing in the present exemplary embodiment related to responses to I/O requests in the computer 32 as an example of processing that suppresses delayed response of a disk.

The present exemplary embodiment resolves issues related to delayed response to I/O requests. A first issue is that changes in fluctuating I/O loads in the computer 32 are not able to be acted on during operation in cases in which the response monitoring time (I/O timeout time) is determined as a fixed value. Namely, situational changes in the I/O load during operation of the computer 32 are not able to be rapidly acted on in cases in which the I/O timeout time is a fixed value. Accordingly, there is sometimes variation in the computer 32 during operation such that the I/O timeout time is too long or too short. For example, when the set I/O timeout time is too long for the situation of I/O load, even if a fault arises in a disk, a slowdown in the system sometimes arises due to the time needed to identify the disk in which the fault arose.

A second issue is that there is a large burden on the user, since a user of the computer 32 needs to set individual response monitoring times. Namely, the burden on a user is increased by the user setting the I/O timeout time since the user needs to ascertain the system configuration to apply settings. Although I/O timeout times are preferably set by processing by a driver that processes I/O, this results in an additional issue in that it is difficult to implement complicated processing in a driver.

In order to resolve the first issue and the second issue above, in the present exemplary embodiment, I/O loads in the system are monitored periodically, and the I/O timeout time is changed according to the condition of the I/O load. Namely, the I/O load in the computer 32 is monitored in order to act upon changes to I/O load during operation of the computer 32. The I/O timeout time is then derived as result of monitoring the I/O load, and the I/O timeout time is set according to the I/O load in the computer 32 during operation. The monitoring processing for the I/O load is implemented by a process executed in the user layer. The driver is accordingly not burdened when the monitoring processing for the I/O load is executed, so that there is no impact on the I/O functionality. Automatically setting the I/O timeout time suppresses burden on the user.

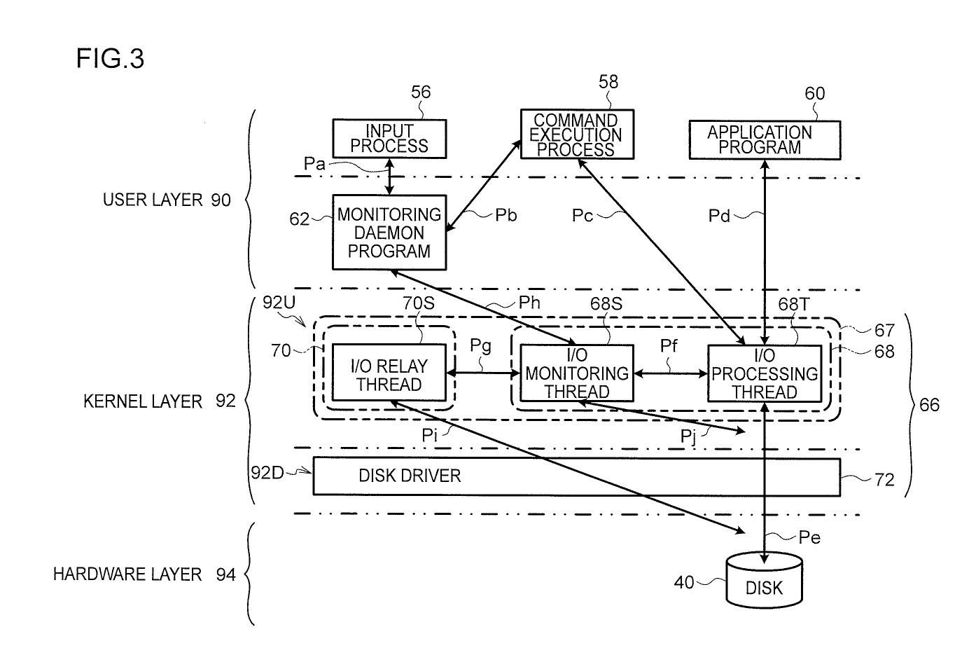

First, processing implemented by the computer 32 to suppress delayed response of the disk may classified as delayed response suppression processing of an initial stage that executes first, or delayed response suppression processing of an operation stage that executes after the initial stage. In the delayed response suppression processing of the initial stage, the I/O timeout time is found and set based on the I/O response time when an I/O load that depends on the I/O load conditions is exerted on the computer 32. In the delayed response suppression processing of the operation stage, the current I/O load, which changes during operation of the computer 32, is detected, and the I/O timeout time is found according to the I/O load and updated. Explanation follows regarding the delayed response suppression processing of the initial stage and the delayed response suppression processing of the operation stage, with reference to FIG. 3.

FIG. 3 illustrates an example of a block diagram looking at the functionality of each program executed by the computer 32. FIG. 3 is an example illustrating a layered structure of layers in which each type of program executed by the computer 32 is executed. FIG. 3 is an example classified into a user layer 90, a kernel layer 92, and a hardware layer 94 as the layered structure.

The drivers 66 are included in the kernel layer 92. The disk driver 72 is classified as a low-level driver 92D that is in the kernel layer 92 close to the hardware layer 94. The I/O monitoring driver 68 and the I/O relay driver 70 are classified as high-level drivers 92U that are in the kernel layer 92 and close to the user layer 90. The drivers in the high-level drivers 92U, including the I/O monitoring driver 68 and the I/O relay driver 70, are drivers related to I/O processing, and can be regarded as I/O processing drivers 67. FIG. 3 illustrates an example in which an I/O monitoring thread 68S and an I/O processing thread 68T are included in the I/O monitoring driver 68. FIG. 3 illustrates an example in which an I/O relay thread 70S is included in the I/O relay driver 70. Moreover, in FIG. 3 reference numerals Pa to Pj are appended to the processing included in the delayed response suppression processing, and explanation follows for processing Pa to Pj.

In the delayed response suppression processing of the initial stage, first, information indicating I/O characteristics is input by the user in an input process 56 for the I/O load conditions. More specifically, the user inputs information indicating I/O characteristics by operating the input device 47. The CPU 42 acquires information indicating the I/O characteristics input by the user, and registers the acquired information in the I/O characteristics table 76. The user can specify the information indicating the I/O characteristics according to the applications operating on the computer 32 by operating the input device 47. In the present exemplary embodiment, the delayed response suppression processing is executed based on the I/O load conditions indicating the I/O characteristics registered in the I/O characteristics table 76.

In the processing Pa, the monitoring daemon program 62 acquires information indicating the I/O characteristics input by the user. The information indicating the I/O characteristics is information that indicates the I/O load ratio (the ratio of reads to writes), and the I/O size, in the computer 32 during operation. The monitoring daemon program 62 generates an I/O load pattern when the information indicating the I/O characteristics has been acquired. A combination of respective information indicating the value of the I/O load exerted on the computer 32, the duration for which the I/O load was exerted, and the form of the exerted I/O load, is an example of the I/O load pattern.

A specific example of the I/O load pattern includes each type of information out of an I/O size (KB), a read ratio (%), a duration for which the load is exerted (seconds), and an I/O type. Information indicating the I/O type is information indicating sequential (seq) or random (rnd). The I/O size is a value of from 0.5 times to 50 times the value of the information indicating the I/O characteristics. The read ratio is a value of from 0.5 times to 2 times the value of the information indicating the I/O characteristics. Moreover, the duration for which the I/O load is exerted is from 1 minute to 5 hours.

Next, in the processing Pb, the monitoring daemon program 62 exerts the I/O load on the computer 32 according to the I/O load pattern, and acquires the I/O response time. Namely, using the information indicating the I/O load pattern and an external command, the monitoring daemon program 62 executes an instruction to exert the I/O load on the computer 32 according to the I/O load pattern. “iotest” is an example of the external command.

Next, in the processing Pc, the computer 32 requests I/O processing by executing the external command using the information indicating the I/O load pattern. Namely, the computer 32 receives the information indicating the I/O load pattern from the monitoring daemon program 62 and an order from the external command, and requests the I/O processing in a command execution process 58. In the command execution process 58, the external command is output to the I/O monitoring driver 68. The monitoring daemon program 62 acquires from the I/O monitoring driver 68, the I/O response time corresponding to the external command output to the I/O monitoring driver 68. In the I/O monitoring driver 68, the I/O processing thread 68T sends an I/O request to the disk driver 72 included in the low-level driver 92D, and notifies the I/O monitoring thread 68S. The I/O monitoring thread 68S monitors the response from the disk driver 72, and sends the response time from the I/O request to the monitoring daemon program 62. The monitoring daemon program 62 acquires, as an I/O response time, the time from when the I/O request was received until the response.

The monitoring daemon program 62 finds the I/O timeout time of the initial stage from the I/O response time. The I/O timeout time and the I/O load information are employed during operation of the computer 32, and are therefore stored as data on the computer 32.

In the delayed response suppression processing of the operation stage, the I/O timeout time found by the delayed response suppression processing of the initial stage is set as an I/O timeout time in the computer 32. The I/O timeout time is then renewed according to changes in the I/O load on the computer 32.

In the operation stage, first, the application program 60 reads/writes data from/to the disk 40 via the I/O processing driver 67 and the disk driver 72. In the processing Pd, the I/O request is output to the I/O processing driver 67 from the application program 60. Namely, in order to use data in the application program 60, information indicating the I/O request is output to the I/O processing thread 68T of the I/O monitoring driver 68 included in the I/O processing driver 67.

In the processing Pe, the I/O processing thread 68T outputs the I/O request to the disk 40 via the disk driver 72. In the processing Pf, the I/O processing thread 68T notifies the I/O monitoring thread 68S after outputting the I/O request to the disk 40 via the disk driver 72. When the I/O monitoring thread 68S has received notification from the I/O processing thread 68T (the processing Pf), in the processing Pj, the I/O monitoring thread 68S monitors the I/O until a response is sent from the disk 40 via the disk driver 72.

When there is no response from the disk 40 via the disk driver 72 even though the I/O timeout time has elapsed, the I/O monitoring thread 68S determines that I/O timeout has occurred. When determination is made that I/O timeout has occurred, in the processing Pg, the I/O monitoring thread 68S outputs an I/O cancellation request to the I/O relay thread 70S. In the processing Ph, when there is an output request for the I/O load information from the monitoring daemon program 62, the I/O monitoring thread 68S outputs the I/O load information to the monitoring daemon program 62. Note that when notification of the I/O timeout time is received from the monitoring daemon program 62, the I/O monitoring thread 68S updates the I/O timeout time. In the processing Pi, when an I/O cancellation request is received from the I/O monitoring thread 68S (the processing Pg), the I/O relay thread 70S outputs to the disk driver 72 a request to cancel I/O on the disk 40.

The monitoring daemon program 62 acquires the I/O load of the computer 32 and the I/O response time at fixed time intervals. The monitoring daemon program 62 finds the I/O timeout time from the I/O load and the I/O response time.

Next, further explanation follows regarding operation of the computer 32.

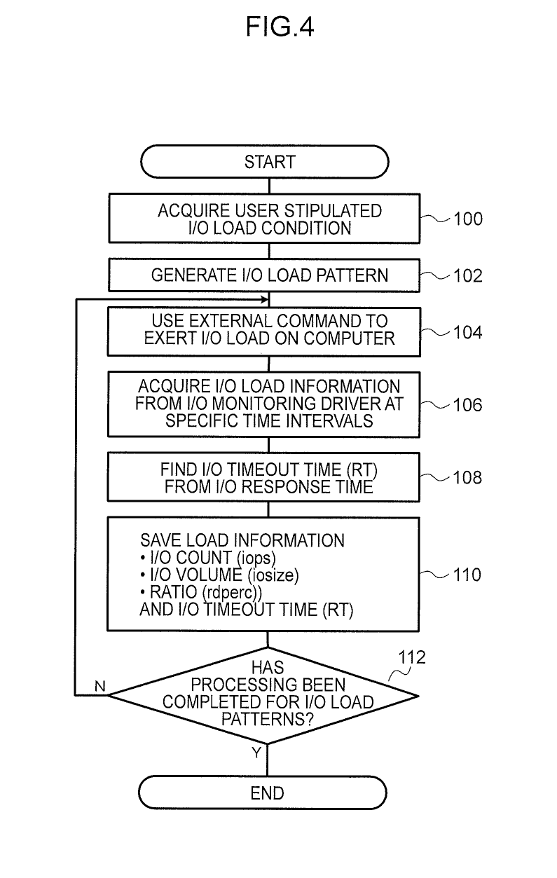

FIG. 4 illustrates a flow of processing of the initial stage of the monitoring daemon program 62 in the user layer 90 executed by the computer 32. The processing routine illustrated in FIG. 4 is executed corresponding to the delayed response suppression processing of the initial stage.

In the computer 32, at step 100, the CPU 42 acquires as the I/O load conditions, information indicating the I/O characteristics input by the user. In more detail, at step 100, the CPU 42 acquires information indicating the I/O characteristics input by the user, and the information indicating the I/O characteristics is registered in the I/O characteristics table 76 as I/O load conditions.

Next, at step 102, the CPU 42 generates the I/O load pattern based on the acquired I/O load conditions. Next, at step 104, the CPU 42 exerts the I/O load according to the I/O load pattern on the computer 32 using the information indicating the I/O load pattern and an external command such as “iotest”. Namely, information indicating the I/O load pattern is output to the I/O monitoring driver 68 by the CPU 42 executing the external command.

Next, at step 106, the CPU 42 acquires, from the I/O monitoring driver 68, I/O load information corresponding to the external command output to the I/O monitoring driver 68. At step 106, the I/O load information is acquired at every specific time interval. The specific time for acquiring the I/O load information is variable. The acquired I/O load information is information indicating a correlation with the I/O response time, and employs the I/O response time, the I/O count, the I/O count ratio, and the I/O volume. The maximum I/O response time in a specific time period (t), or an average I/O response time in a specific time period (t), is an example of the I/O response time. The I/O count in a specific time (t) is an example of the I/O count. The ratio (%) of read I/O counts in a specific time (t) is an example of the I/O count ratio. The I/O volume in a specific time (t) is an example of the I/O volume.

Next, at step 108, the CPU 42 finds the I/O timeout time based on the I/O response time. The following Equation (1) is an example of a relationship between the I/O load information and the I/O timeout time. The Equation (1) illustrates an example in which the maximum I/O response time in the specific time (t) is employed as an example of the I/O response time.

RTᵢ(iopsᵢ, iosizeᵢ, rdpercᵢ)=K×max(rtᵢⱼ) (1)

Wherein, RT: I/O timeout time (seconds)
rt: I/O response time (seconds)
max( ) maximum I/O response time (seconds)
iops: I/O volume in the specific time (t) (see Equation (2))
iosize: I/O volume in the specific time (t) (KB)
rdperc: read I/O count ratio (%) in the specific time (t) (see Equation (3))
K: I/O timeout coefficient (1≦K≦2)
i: condition indicating the load exerted on the computer
j: number of times measured with the specific I/O load condition

iops₁=(number of reads in time t+number of writes in time t)/t (2)

rdpercᵢ=(number of reads/(number of reads+number of writes))×100 (3)

Equation (1) illustrates that the I/O timeout time (RT) is obtained by multiplying the I/O timeout coefficient by the maximum I/O response time (rt) in the specific I/O load condition.

Next, at step 110, the CPU 42 saves a portion of the information of the acquired I/O load information (iops, iosize, rdpeprc), and the data of the I/O timeout time (RT), in the memory 44 in the format indicated below.
RT={RT₁, RT₂, . . . , RTₙ}

### Wherein,

RTᵢ={RTᵢ, iopsᵢ, iosizeᵢ, rdpercᵢ}

When data saving of the I/O load information and the I/O timeout time has completed, processing transitions to step 112. At step 112, the CPU 42 determines whether or not the processing of step 104 to step 110 has been completed for all the I/O load patterns generated at step 102. When the above processing using the I/O load patterns is incomplete, the CPU 42 makes negative determination at step 112, and processing returns to step 104. When the above processing has been completed for all of the I/O load patterns, the CPU 42 makes affirmative determination at step 112, and ends the current processing routine.

Next, further explanation follows regarding processing to find the timeout time in the processing of the initial stage of the monitoring daemon program 62.

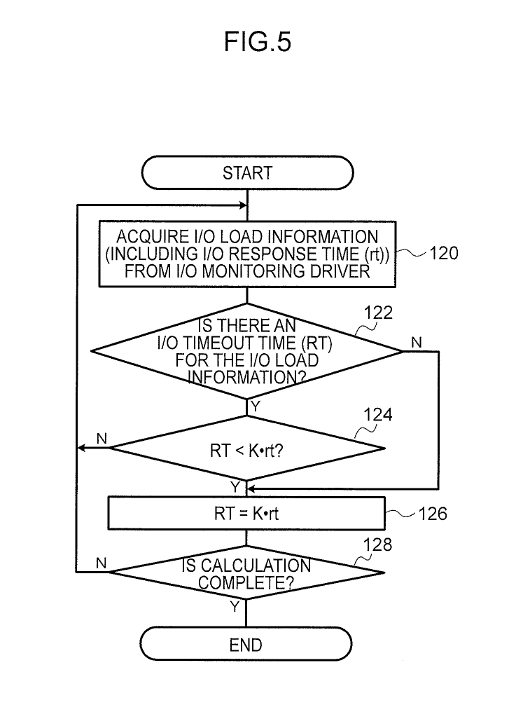

FIG. 5 illustrates a flow of processing to find the timeout time in the processing of the initial stage of the monitoring daemon program 62. The processing routine illustrated in FIG. 5 corresponds to the processing of step 106 and step 108 illustrated in FIG. 4.

First, similarly to at step 106 of FIG. 4, at step 120, the CPU 42 acquires from the I/O monitoring driver 68 the I/O load information corresponding to the external command output to the I/O monitoring driver 68. The acquired I/O load information includes the I/O response time, the I/O count, the I/O count ratio, and the I/O volume.

Next, at step 122, the CPU 42 determines whether or not the I/O timeout time for the I/O load information is saved in the memory 44. When the I/O timeout time (RT) for the I/O load information is not saved in the memory 44, the CPU 42 makes negative determination at step 122, and finds the I/O timeout time (RT=K•rt) at step 126. Namely, at step 126, the value of the I/O response time (rt) acquired at step 120 multiplied by the I/O timeout coefficient (K) is found as the I/O timeout time (RT).

When the I/O timeout time for the I/O load information has been saved in the memory 44, the CPU 42 makes affirmative determination at step 122, and processing transitions to step 124. At step 124, determination is made as to whether or not RT<K•rt, using the I/O timeout time (RT) saved in the memory 44, and the value of the I/O response time acquired at step 120 multiplied by the I/O timeout coefficient K (K•rt). When RT<K•rt, the CPU 42 makes affirmative determination at step 124, and processing transitions to step 128 after the I/O timeout time has been found at step 126. When “RT≧K•rt”, the CPU 42 makes negative determination at step 124. Negative determination is made at step 124 when RT≧K•rt, and the CPU 42 returns processing to step 120.

Next, at step 128, the CPU 42 determines whether or not the calculation of the I/O timeout time has been completed. When negative determination is made at step 128, the CPU 42 returns processing to step 120, and the processing is repeated. When affirmative determination is made at step 128, the CPU 42 ends the current processing routine.

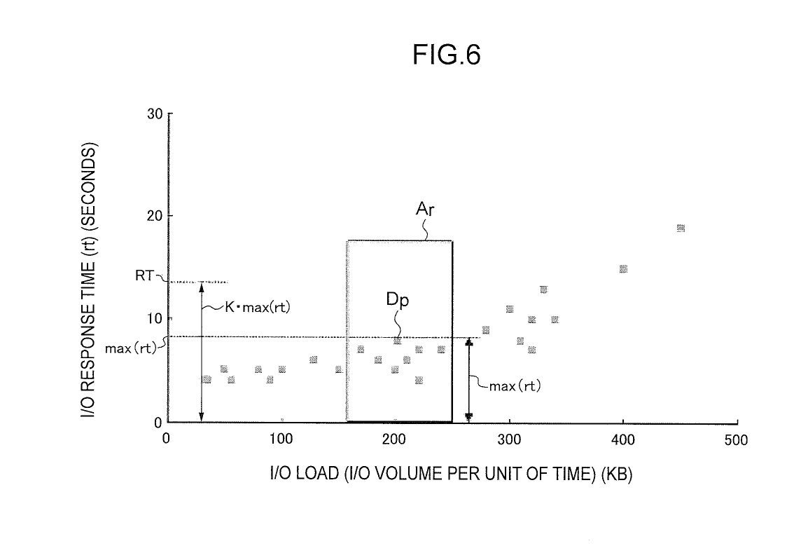

FIG. 6 illustrates an example of a relationship between the I/O load and the I/O response time. In FIG. 6, the I/O load information acquired at each specific time interval while the load according to the I/O load pattern is being exerted are points within the range of area Ar. Moreover, in FIG. 6, the maximum I/O response time corresponds to the point Dp. An example is illustrated in which the I/O timeout time (RT) is determined by applying Equation (1) using the maximum I/O response time from out of the I/O load information acquired for each of the specific time intervals from the I/O monitoring driver 68.

Next, explanation follows regarding operation in the operation stage of the monitoring daemon program 62.

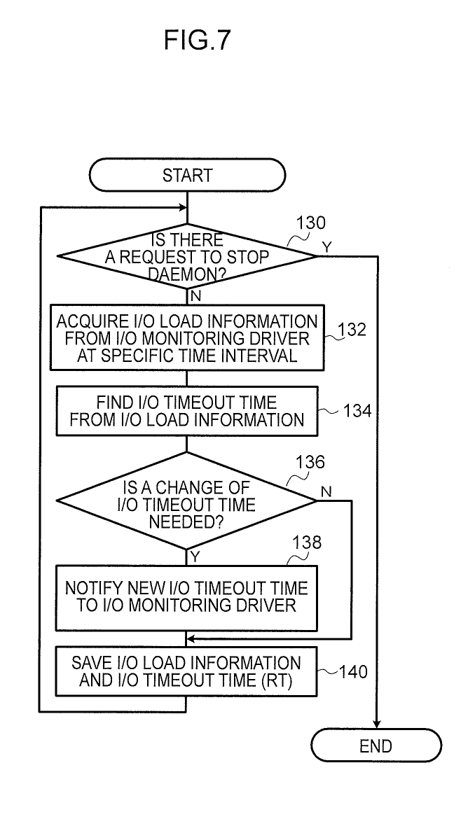

FIG. 7 illustrates a flow of processing of the operation stage of the monitoring daemon program 62 executed in the computer 32 in the user layer 90. The processing routine illustrated in FIG. 7 is executed corresponding to the delayed response suppression processing of the operation stage.

At step 130, the CPU 42 determines whether or not a stop request of the monitoring daemon program 62, such as a power interruption, has been issued. When a stop request has been issued, the CPU 42 makes affirmative determination at step 130, and ends the current processing routine. When negative determination is made at step 130, the CPU 42 transitions processing to step 132. The processing of step 132, similarly to the processing of step 106 illustrated in FIG. 4, and acquires from the I/O monitoring driver 68, I/O load information corresponding to the external command output to the I/O monitoring driver 68. Next, at step 134, similarly to in the processing of step 108 illustrated in FIG. 4, the CPU 42 finds the I/O timeout time based on the I/O response time.

In the operation stage, the I/O timeout time is corrected while measuring the I/O response time for the I/O load. Namely, when the acquired I/O timeout time is longer than the I/O timeout time found at the initial stage, the found I/O timeout time is set based on the acquired I/O response time. However, when the acquired I/O timeout time is shorter, the I/O timeout time is preserved.

More specifically, at step 136, the CPU 42 compares the currently set I/O timeout time against the I/O timeout time found at step 134, and determines whether or not there is a need to change the I/O timeout time. When the currently set I/O timeout time and the I/O timeout time found at step 134 match, or are within a predetermined threshold value of time of each other, negative determination is made at step 136 since the I/O timeout time can be maintained, and processing transitions to step 140. Next, at step 140, similarly to in the processing of step 110 illustrated in FIG. 4, the CPU 42 saves a portion of the information out of the acquired I/O load information (iops, iosize, rdperc) and the data of the I/O timeout time (RT), and processing returns to step 130.

When the currently set I/O timeout time and the I/O timeout time found at step 134 differ or are outside the threshold value of time, affirmative determination is made at step 136 since the I/O timeout time needs to be changed, and processing transitions to step 138. At step 138, the CPU 42 notifies the I/O timeout time found at step 134, namely, the new I/O timeout time, to the I/O monitoring driver 68, and processing transitions to step 140. In the I/O monitoring driver 68, the I/O timeout time is updated by notification of the new I/O timeout time as described below.

The determination processing at step 136 may include determination processing performed using the magnitude of the I/O timeout time found at step 134 against the currently set I/O timeout time. For example, when there is no request to set the I/O timeout time shorter, affirmative determination may be made in the determination processing at step 136 when the I/O timeout time found at step 134 exceeds the currently set I/O timeout time. Moreover, a time range may be predetermined to lengthen or shorten the I/O timeout time.

However, in the processing of the operation stage of the monitoring daemon program 62, the setting processing of the timeout time becomes unstable when the set timeout time is not acquirable. Further explanation therefore follows regarding processing to find the timeout time when the set timeout time is not acquirable.

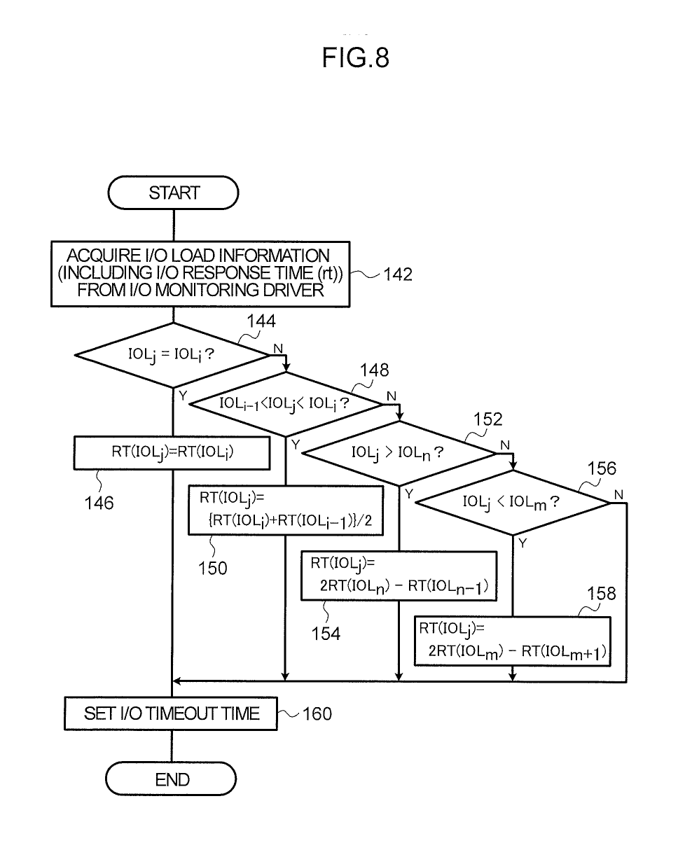

FIG. 8 illustrates a flow of processing in the processing in the operation stage of the monitoring daemon program 62 to find the timeout time. The processing routine illustrated in FIG. 8 is executed when the set timeout time is not acquirable in the processing of the operation stage of the monitoring daemon program 62.

First, at step 142, similarly to at step 132 of FIG. 7, the CPU 42 acquires the I/O load information from the I/O monitoring driver 68. Note that the acquired I/O load information includes the I/O response time.

In the explanation of FIG. 8, the portion of the I/O load information is denoted IOL (iops, iosize, rdperc). Explanation follows of a case in which a variable i indicating the initial stage, a variable j indicating the operation stage, a variable n indicating the maximum value of the initial stage, or a variable m indicating the minimum value of the initial stage, is appended to information IOL. Namely, the portion of the information IOL of the I/O load information of the initial stage is IOLᵢ (iopsᵢ, iosizeᵢ, rdpercᵢ), and is sometimes abbreviated as IOLᵢ.

Next, at step 144, the CPU 42 determines whether or not the information IOL of the operation stage and the information IOL of the initial stage match each other (whether IOLⱼ=IOLᵢ), and processing transitions to step 148 when negative determination is made. When affirmative determination is made at step 144, at step 146, the CPU 42 sets the I/O timeout time of the information IOL of the initial stage as the I/O timeout time RT of the information IOL of the operation stage, and processing transitions to step 160. Namely, RT (IOLᵢ)=RT (IOLᵢ) is set.

At step 148, the CPU 42 determines whether or not the information IOL of the operation stage is within the information IOL of the initial stage (IOLᵢ₋₁<IOLⱼ<IOLᵢ), and processing transitions to step 152 when negative determination is made. When affirmative determination is made at step 148, at step 150, the CPU 42 sets the I/O timeout time RT found via the following Equation (4) as the I/O timeout time RT of the information IOL of the operation stage, and processing transitions to step 160.

RT(IOLᵢ)=[RT(IOLᵢ)+RT(IOLᵢ₋₁)]/2 (4)

At step 152, the CPU 42 determines whether or not the information IOL of the operation stage exceeds the maximum information IOL of the initial stage (whether IOLⱼ>IOLₙ), and processing transitions to step 156 in cases in which negative determination is made. When affirmative determination is made at step 152, at step 154, the CPU 42 sets the I/O timeout time RT found via Equation (5) below as the I/O timeout time RT of the information IOL of the operation stage, and processing transitions to step 160.

RT(IOLⱼ)=2RT(IOLₙ)−RT(IOLₙ−1) (5)

At step 156, the CPU 42 determines whether or not the information IOL of the operation stage is less than the minimum information IOL of the initial stage (whether IOLⱼ<IOLₘ), and processing transitions to step 160 in cases in which negative determination is made. When affirmative determination is made at step 156, at step 158, the CPU 42 sets the I/O timeout time RT found via Equation (6) below as the I/O timeout time RT of the information IOL of the operation stage, and processing transitions to step 160.

RT(IOLⱼ)=2RT(IOLₘ)−RT(IOLₘ₊₁) (6)

Note that when negative determination is made at step 156, a predetermined value may be found as the I/O timeout time RT.

At step 160, the CPU 42 sets the I/O timeout time RT found by the processing above, and ends the current routine.

Next, further explanation follows regarding processing of the initial stage of the I/O monitoring driver 68.

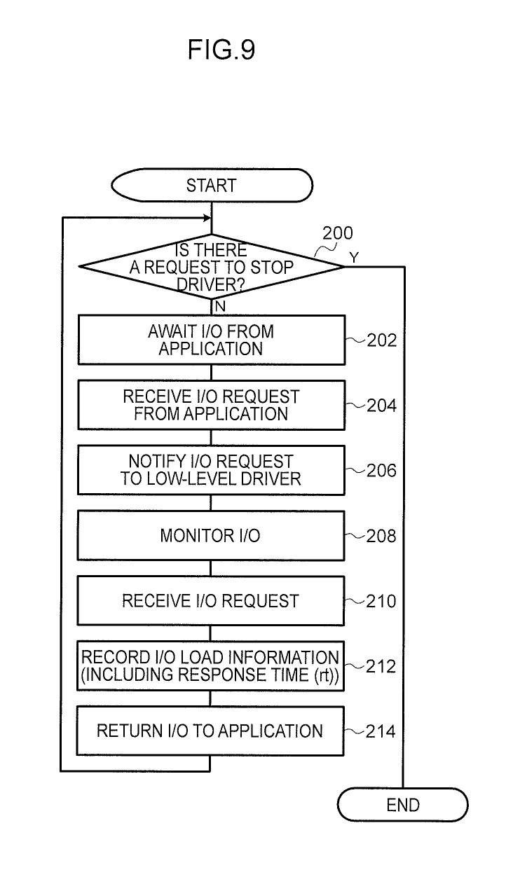

FIG. 9 illustrates a flow of processing of the initial stage of the I/O monitoring driver 68. The processing routine illustrated in FIG. 9 is executed corresponding to the delayed response suppression processing of the initial stage.

At step 200, the CPU 42 determines whether or not a stop request for the I/O monitoring driver 68 has been issued, such as a power interruption. When a stop request has been issued, the CPU 42 makes affirmative determination at step 200, and ends the current processing routine. When negative determination is made at step 200, the CPU 42 transitions processing to step 202. The processing of step 202 is processing that awaits an I/O request issued from the application program 60. When an I/O request is issued from the application program 60, the CPU 42 advances processing to step 204, and receives the I/O request from the application program 60. At the next step 206, the CPU 42 notifies the I/O request to the low-level driver, namely, to the disk driver 72, processing transitions to the next step 208, and I/O monitoring starts.

After the I/O monitoring starts, when an I/O response is issued by the low-level driver, namely, by the disk driver 72, the CPU 42 receives the I/O response at the next step 210. In the I/O monitoring driver 68, when an I/O response is issued by the disk driver 72, I/O load information, including an I/O response time, of from when the I/O request was notified to the disk driver 72 until the I/O response was issued, is acquired and recorded. Namely, at the next step 212, the CPU 42 records the I/O load information including the I/O response time, of from when the I/O request was notified to the disk driver 72 until the I/O response was issued. Next, at step 214, the CPU 42 ends the I/O monitoring, and after replying to the application program 60 with the information representing the I/O response, processing returns to step 200.

The I/O monitoring driver 68 requests the I/O load information from the monitoring daemon program 62 at each specific time interval for the delayed response suppression processing. Next, explanation follows regarding the processing of the I/O monitoring driver 68 when the I/O load information is requested from the monitoring daemon program 62.

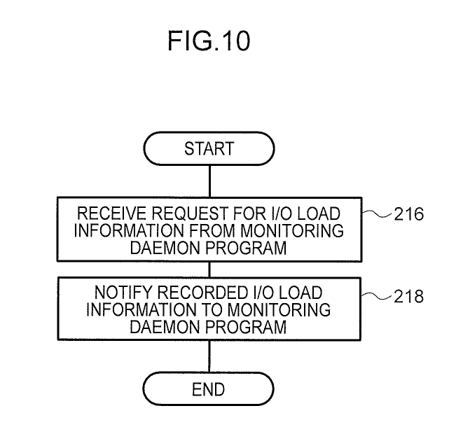

FIG. 10 illustrates a flow of processing when the I/O load information of the I/O monitoring driver 68 is requested. The processing routine illustrated in FIG. 10 is executed as an interruption processing routine when a request for I/O load information from the monitoring daemon program 62 has not been issued.

First, when a request for I/O load information is issued from the monitoring daemon program 62 to the I/O monitoring driver 68, the processing routine illustrated in FIG. 10 is executed, and at step 216, the CPU 42 receives the request for the I/O load information from the monitoring daemon program 62. Next, at step 218, the CPU 42 notifies the I/O load information recorded in the memory 44 to the monitoring daemon program 62, and ends the current processing routine.

Next, further explanation follows regarding processing of the operation stage of the I/O monitoring driver 68.

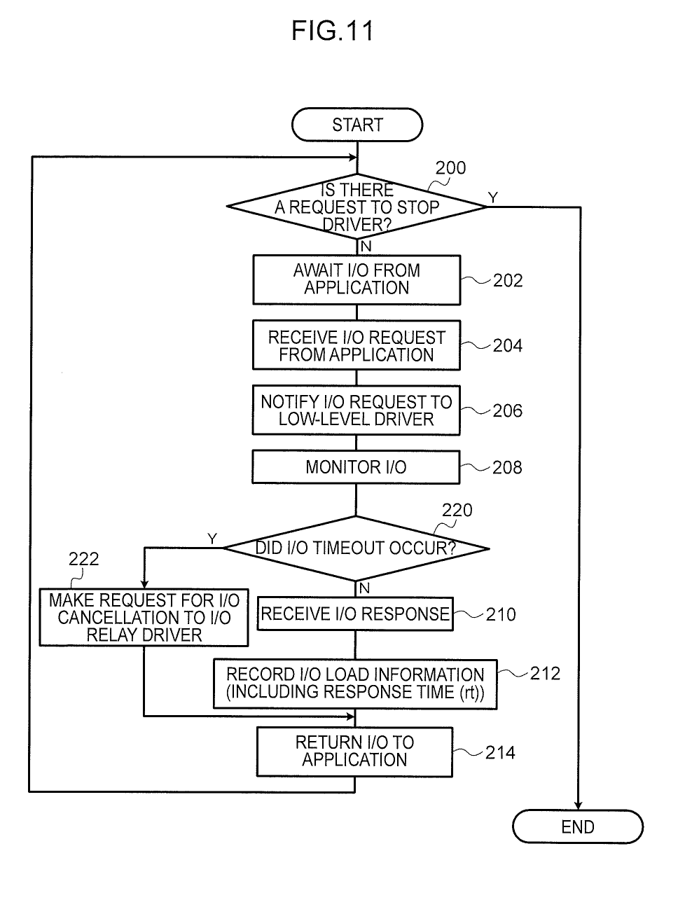

FIG. 11 illustrates a flow of processing of the operation stage of the I/O monitoring driver 68. The processing routine illustrated in FIG. 11 is executed corresponding to the delayed response suppression processing of the operation stage. Note that since the processing routine illustrated in FIG. 11 is processing substantially similar to the processing routine illustrated in FIG. 9, the same reference numerals are allocated to corresponding portions, and detailed explanation thereof is omitted. The processing routine of the operation stage illustrated in FIG. 11 and the processing routine of the initial stage illustrated in FIG. 9 differ in that the processing routine of the operation stage is the routine processing of the initial stage to which timeout processing (step 220, step 222) has been added.

After the I/O request is notified to the disk driver 72 from the application program 60, the CPU 42 starts I/O monitoring until a stop request is issued for the I/O monitoring driver 68 (steps 200 to 208).

When the I/O monitoring is started, at step 220, the CPU 42 determines whether or not an I/O monitoring timeout occurred. Namely, the CPU 42 determines that an I/O timeout has occurred when there has been no I/O response from the disk driver 72, and the elapsed time since the I/O request was notified to the disk driver 72 has exceeded the I/O timeout time. When an I/O response is issued from the disk driver 72 within the I/O timeout time, the CPU 42 makes negative determination at step 220, records the I/O load information, and replies to the application program 60 with information indicating the I/O response (steps 210 to 214).

The CPU 42 makes affirmative determination at step 220 when there has been no I/O response from the disk driver 72, and the elapsed time since the I/O request was notified to the disk driver 72 has exceeded the I/O timeout time, and processing transitions to step 222. At step 222, the CPU 42 outputs an I/O cancellation request to the I/O relay driver 70. Namely, in the processing of step 222, the I/O monitoring driver 68 makes an I/O cancellation request to the I/O relay driver 70, and processing transitions to step 214. The detail explanation later, when the I/O relay driver 70 receives an I/O cancellation request from the I/O monitoring driver 68, the I/O relay driver 70 notifies a request to suspend the I/O request that was already issued to the disk driver 72.

The I/O monitoring driver 68 sometimes makes a request to change the I/O timeout time by the monitoring daemon program 62 for the delayed response suppression processing. Therefore explanation next follows regarding processing of the I/O monitoring driver 68 when a request to change the I/O timeout time is made by the monitoring daemon program 62.

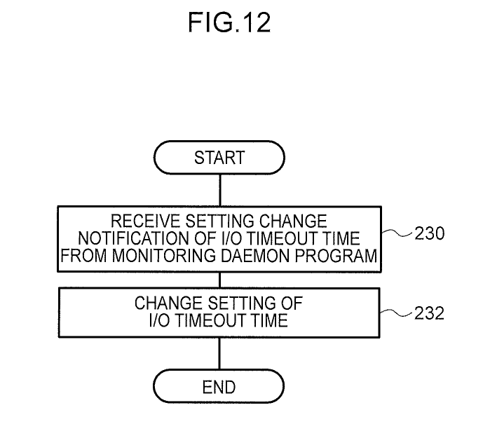

FIG. 12 illustrates a flow of processing of when a request is made to change the I/O timeout time of the I/O monitoring driver 68. The processing routine illustrated in FIG. 12 is executed as an interruption processing routine for when a request to change the I/O timeout time is issued by the monitoring daemon program 62.

First, when a request to change the I/O timeout time is issued from the monitoring daemon program 62 to the I/O monitoring driver 68, the processing routine illustrated in FIG. 12 is executed. First, at step 230, the CPU 42 receives an I/O timeout time change notification from the monitoring daemon program 62. Next, at step 232, the CPU 42 changes the I/O timeout time recorded in the memory 44 to the I/O timeout time notified by the monitoring daemon program 62, and ends the current processing routine.

Next, further explanation follows regarding processing of the I/O relay driver 70. The I/O relay driver 70 executes processing when I/O cancellation is requested by the I/O monitoring driver 68.

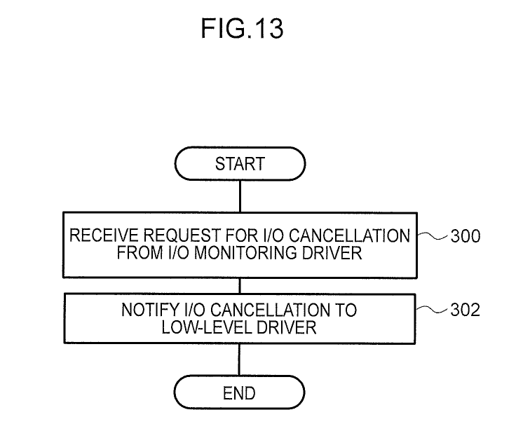

FIG. 13 illustrates a flow of processing of the I/O relay driver 70. The processing routine illustrated in FIG. 13 is executed when I/O cancellation is requested by the I/O monitoring driver 68.

First, at step 300, the CPU 42 receives an I/O cancellation request from the I/O monitoring driver 68. Next, at step 302, the CPU 42 notifies a request to cancel the I/O request already issued to the disk driver 72, and ends the current processing routine. When the disk driver 72 receives a request to suspend the I/O request from the I/O relay driver 70, the disk driver 72 executes processing to suspend the I/O request by erasing the I/O request already issued from the application program 60.

As explained above, in the present exemplary embodiment, the I/O timeout time can be changed according to the I/O load arising due to business processing executed on the computer 32. Accordingly, the I/O timeout time can be suppressed from being set too long or too short for the business processing executed on the computer 32. Setting the I/O timeout time based on the business processing enables faults to be detected in execution of business processing without causing the business processing to be prolonged, even when a fault has arisen in a disk or recording device. In this manner, the present exemplary embodiment can improve response performance in an information processing system that executes business processing using a computer.

Moreover, the present exemplary embodiment enables faults in disks and processing devices to be detected quickly. Accordingly, a disk or recording device subject to a fault can be identified, and the disk or recording device can be disconnected from the computer or information processing system, thereby enabling slowdowns to be suppressed in processing by the computer or business processing system.

Moreover, since the I/O timeout time can be changed according to the I/O load arising due to the business processing, the present exemplary embodiment enables a reduction in labor by the user to set the I/O timeout time while ascertaining the system configuration. Burden on the user is accordingly reduced.

Explanation has been given of an example in which the information processing device is implemented by the computer 32. However, there is no limitation to this configuration, and obviously, various improvements and modifications may be made within a range not exceeding the spirit of the above explanation.

Although explanation has been given above of a mode in which a program is pre-stored (installed) in a storage section, there is no limitation thereto. For example, the information processing program of the technology disclosed herein may be provided in a form recorded on a recording medium, such as a CD-ROM or a DVD-ROM.

One aspect of technology disclosed herein enables response performance to be increased in an information processing system.

All cited documents, patent applications and technical standards mentioned in the present specification are incorporated by reference in the present specification to the same extent as if the individual cited document, patent application, or technical standard was specifically and individually indicated to be incorporated by reference.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device, comprising:
a processor that executes a process, the process comprising:
acquiring a load condition that is predetermined according to an information processing system, that is related to input and output of data to and from a device included in the information processing system and that determines a load to be added to the information processing system;
based on the acquired load condition, finding a load to be added to the information processing system during operation, and adding the found load to the information processing system;
acquiring a response time of the device with respect to a request for input or output of data when the load is added to the information processing system, and acquiring load information indicating a correlation with the response time; and
based on the acquired load information, setting a response monitoring time from the request for input or output of data to or from the device until the device responds.

2. The information processing device of claim 1, wherein the load information is a ratio between data input and data output.

3. The information processing device of claim 1, wherein the load information is a data volume of data input or output.

4. The information processing device of claim 1, wherein:
the load condition is registered in a table; and
the acquisition of the load condition comprises reading out load conditions registered in the table.

5. The information processing device of claim 1, wherein, when the load is added to the information processing system, a load pattern representing the load added to the information processing system during operation is found based on the acquired load condition, and the load indicated by the found load pattern is added to the information processing system.

6. The information processing device of claim 1, the process further comprising:
monitoring for a response to the request for input or output of data after the request for input or output of data is made; and
erasing the request for input or output of data to or from the device if the response is not received within the monitoring time.

7. An information processing method, comprising:
acquiring a load condition that is predetermined according to an information processing system, that is related to input and output of data to and from a device included in the information processing system and that determines a load to be added to the information processing system;
based on the acquired load condition, finding a load to be added to the information processing system during operation, and adding the found load to the information processing system;
acquiring a response time of the device with respect to a request for input or output of data when the load is added to the information processing system, and acquiring load information indicating a correlation with the response time; and
based on the acquired load information, setting a response monitoring time from the request for input or output of data to or from the device until the device responds.

8. The information processing method of claim 7, wherein the load information is a ratio between data input and data output.

9. The information processing method of claim 7, wherein the load information is a data volume of data input or output.

10. The information processing method of claim 7, wherein:
the load condition is registered in a table; and
the acquisition of the load condition comprises reading out load conditions registered in the table.

11. The information processing method of claim 7, wherein, when the load is added to the information processing system, a load pattern representing the load added to the information processing system during operation is found based on the acquired load condition, and the load indicated by the found load pattern is added to the information processing system.

12. The information processing method of claim 7, further comprising:
monitoring for a response to the request for input or output of data after the request for input or output of data is made; and
erasing the request for input or output of data to or from the device if the response is not received within the monitoring time.

13. A non-transitory recording medium storing an information processing program that causes a computer to execute a process, the process comprising:
acquiring a load condition that is predetermined according to an information processing system, that is related to input and output of data to and from a device included in the information processing system and that determines a load to be added to the information processing system;
based on the acquired load condition, finding a load to be added to the information processing system during operation, and adding the found load to the information processing system;
acquiring a response time of the device with respect to a request for input or output of data when the load is added to the information processing system, and acquiring load information indicating a correlation with the response time; and
based on the acquired load information, setting a response monitoring time from the request for input or output of data to or from the device until the device responds.
